(19) United States
(12) Patent Application Publication
(10) Pub. No.: US 2008/0040162 A1
(43) Pub. Date: Feb. 14, 2008

(54) System for Processing and Testing of Electronic Forms and Associated Templates

(75) Inventor: Claudia D. K. Brice, Harleysville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/834,802

(22) Filed: Aug. 7, 2007

Related U.S. Application Data
(60) Provisional application No. 60/821,726, filed on Aug. 8, 2006.
(60) Provisional application No. 60/941,969, filed on Jun. 5, 2007.

(51) Int. Cl. G06Q 50/00; G06F 17/30; G06F 17/40

(52) U.S. Cl. 705/3; 705/2

(57) ABSTRACT

A system processes and tests forms and associated templates. A form repository includes data representing different electronic forms. A repository of information includes a plurality of sets of HIPAA compliant test data associated with a plurality of different electronic forms. The HIPAA compliant test data is used in populating a plurality of different electronic forms for review. A user interface provides data representing at least one display image enabling a user to select an electronic form from the form repository. A test form generator uses the test data to automatically populate an electronic form selected by a user via the user interface with a HIPAA compliant set of data. An output generator provides a populated electronic form to a user for reproduction and review.

### FIELD OF THE INVENTION

The present invention relates to processing and testing of forms and associated templates, and in particular to processing and testing of forms and associated templates in a healthcare enterprise environment.

### BACKGROUND OF THE INVENTION

Many tasks are performed when installing a clinical and financial information processing system in a healthcare enterprise. One such task is the preparation of enterprise-approved electronic forms for data entry, data update, form distribution and use and/or data retrieval and review. In operation, such forms are populated with data retrieved from the information processing system. For example, financial information from the medical information processing system may be displayed on an electronic form to be updated by a billing clerk, and/or may be inserted into an insurance claim form to be sent to an insurance company; or patient data may be inserted into a wrist band form which is printed for application to a patient. Such forms, and many others like them, need to be developed, reviewed, approved and implemented as a part of the installation of the medical information processing system.

Developers generate forms, called templates, which include blank locations where data from the information processing system is to be inserted. In operation, the blanks in such forms are automatically filled with information from the clinical and financial information processing system when the form is used. Thus, to develop these forms, test data simulating data present in the clinical and financial information processing system need to be available to the developer. This presents a number of problems. Firstly, for example, in early stages of the installation of the clinical and financial information processing system, there is typically no data available in the processing system which may be used in testing the operation of the forms. This delays development of forms until later in the installation process where data is actually generated and stored in the information processing system.

Secondly, current patient privacy concerns prohibit disclosure of actual live patient representative data to parties who are not authorized to see it. (For example, in the United States, the health insurance portability and accountability act (HIPAA) provides statutory protections for the privacy of patients.) Because test forms need to be evaluated and reviewed by healthcare enterprise administrative personnel, who may not be authorized to see actual patient data, such data may not be used to test the operation of the forms. This requires that test data be generated which cannot be connected with a patient. This can be time consuming because to test some forms requires a substantial amount of test data. In addition, form developers typically do not comprehend the structure and inner workings of the processing system. That is, they typically do not know how data is stored within the processing system. There may be a plurality of different databases, the respective databases containing pluralities of different tables, the respective tables capable of holding records having a plurality of fields. Because a developer does not know the inner structure of the data within the processing system, generating test data is even more time consuming, and typically requires multiple developers with different skills.

Known systems exist for generating test data from existing real (live) data. They involve detecting data which associates a patient with data and changing the data to break the association. This makes the test data compliant with the HIPAA requirements. However, this requires that data exists in the processing system. This does not solve the problem of the delay inherent in implementing electronic forms when installing a processing system due to the lack of data in the processing system. It also does not address the lack of knowledge of the form developer of the structure of the data.

Known systems for developing electronic forms typically do not use personal computer tools such as Microsoft Word™ as a design tool, but rather use mainframe toolsets. Known systems also typically get data directly from an information processing system database for populating the blanks in the electronic forms during the development process. To test an iteration of a template form under development, the information processing systems require a relatively large amount of developer time to perform the steps required to install an updated template form in the clinical and financial information system (termed checking-in) and to navigate to the correct clinical and financial information system function to produce sample output using that template. A system according to invention principles addresses these deficiencies and related problems.

### BRIEF SUMMARY OF THE INVENTION

In accordance with principles of the present invention, a system processes and tests forms and associated templates. A form repository includes data representing different electronic forms. A repository of information includes a plurality of sets of HIPAA compliant test data associated with a plurality of different electronic forms. The HIPAA compliant test data is used in populating a plurality of different electronic forms for review. A user interface provides data representing at least one display image enabling a user to select an electronic form from the form repository. A test form generator uses the test data to automatically populate an electronic form selected by a user via the user interface with a HIPAA compliant set of data. An output generator provides a populated electronic form to a user for reproduction and review.

### BRIEF DESCRIPTION OF THE DRAWING

In the drawing:

FIG. 1 is a block diagram of a system for processing and testing of electronic forms and associated templates according to principles of the present invention;

FIG. 2a and b illustrate respective user interface forms used by a developer in the operation of the system for processing and testing of electronic forms according to principles of the present invention;

FIG. 3 is a table illustrating a portion of data associating a plurality of sets of HIPAA compliant data with corresponding business practices and different electronic forms according to principles of the present invention;

FIG. 4 is a listing of a portion of HIPAA compliant test data for use in processing and testing of electronic forms according to principles of the present invention;

FIG. 5 is a diagram of an electronic form template in various stages of development and test according to principles of the present invention;

FIG. 6 is a table of a mapping between placeholders for use in developing electronic form templates and test data according to principles of the present invention; and

FIG. 7 is a listing of a portion of an extensible style sheet language (XSL) representation of an electronic form template used to process and test electronic forms and associated templates according to principles of the present invention

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, system for processing and testing of electronic forms and associated templates, or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. A graphical user interface (GUI) uses graphical display images, as opposed to textual display images, when generating the UI. A form, as used herein, is a type of UI display image. A form UI display image includes display elements, such as textual display, which prompt the user to enter particular information; and display elements, such as text boxes, check boxes etc., into which the user, using the input devices, may enter the particular information.

A workflow processor, as used herein, processes data to determine tasks to add to a task list, remove from a task list, or modify tasks incorporated on, or for incorporation on, a task list. A task list is a list of tasks for performance by a worker or device or a combination of both. A workflow processor may or may not employ a workflow engine. A workflow engine, as used herein, is a processor executing an executable application in response to predetermined process definitions that implement processes responsive to events and event associated data. The workflow engine implements processes in sequence and/or concurrently, responsive to event associated data to determine tasks for performance by a device and/or worker and for updating task lists of a device and/or worker to include determined tasks. A process definition is definable by a user and comprises a sequence of process steps including one or more of: start, wait, decision and task allocation steps for performance by a device and or worker, for example. An event is an occurrence affecting operation of a process implemented using a process definition.

A workflow management system is a software system that manages processes. It includes a process definition function that allows users to define a process that should be followed, an event monitor, which captures events from a healthcare information system and communicates the results to the workflow management system. A processor in the management system tracks which processes are running, for which patients, and what step needs to be executed next, according to a process definition. The management system includes a procedure for notifying clinicians of a task to be performed, through their work-lists and a procedure for allocating and assigning tasks to specific users or specific teams. A document or record comprises a compilation of data in electronic form and is the equivalent of a paper document and may comprise a single, self-contained unit of information.

Health insurance portability and accountability act (HIPAA) compliant test data as used herein is simulated data of a type which would normally be stored in a healthcare information processing system. The data is fabricated so that it does not contain references to any actual patient, but is complete in the sense that it contains sufficient data to test the operation of the most complicated electronic form template.

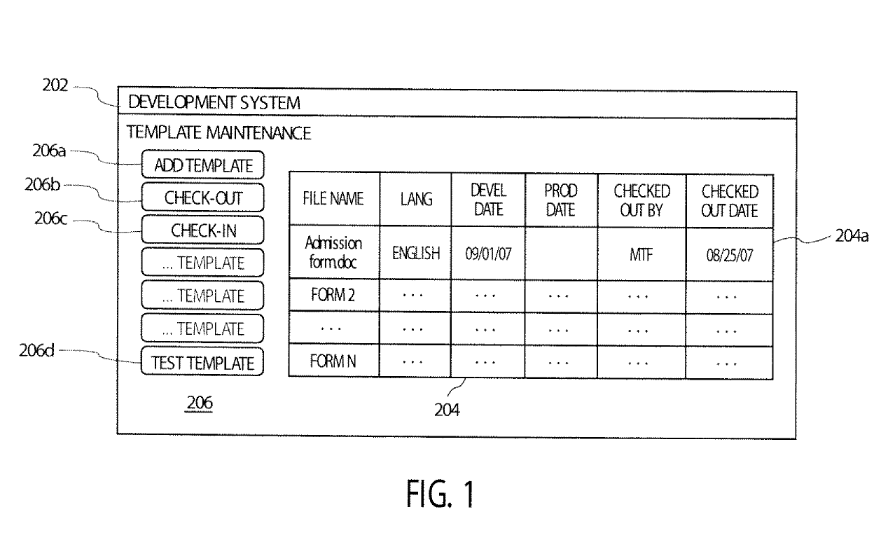

FIGS. 1 is a block diagram of a system 100 for processing and testing of electronic forms and associated templates according to principles of the present invention In FIG. 1, the system 100 includes a form data repository 104 including data representing different electronic forms and an information repository 102 including a plurality of sets of health insurance portability and accountability act (HIPAA) compliant test data associated with a plurality of different electronic forms. The HIPAA compliant test data is used for populating a plurality of different electronic forms for review. A user interface 106 provides data representing at least one display image enabling a user to select an electronic form from the form data repository 104. The image representative data is provided to an image display device 115. The user interface 106 also receives data from a user input device, illustrated as a keyboard 108 in the illustrated embodiment in FIG. 1. The user interface 106 enables a user to select an electronic form from the form repository 104.

A test form generator 110 uses the UI data from the UI 106 to initiate populating an electronic form selected by a user with a HIPAA compliant set of test data. Data from the form data repository 104 representing the selected form is retrieved by the test form generator 110. The test form generator also retrieves HIPAA compliant test data from the information repository 102 associated with the selected electronic form. The test form generator 110 uses the test data in automatically populating the electronic form selected by the user via the user interface 106 with the HIPAA compliant set of data for use in a healthcare information system capable of generating and communicating documents prior to set-up of the healthcare information system for operational (not-test) use. Data representing the populated form is supplied to an output generator 112. The output generator 112 provides the populated electronic form to the user for reproduction and review. In FIG. 1, the output generator 112 is illustrated as supplying a signal to the display device 115 representing an image of the populated electronic form. One skilled in the art understands that the electronic form may be supplied as an electronic form (e.g. as an image file) to one or more different display devices for review, or may be printed on one or more printers (not shown) and distributed by hand in paper form for review.

The information repository 102 includes a plurality 103 of sets of HIPAA compliant test data which do not require real (non-test) patient data, real (non-test) physician data and/or installation or setup of the healthcare information for operational (non-test) use. In the illustrated embodiment, the information repository 102 also includes data 105 which associates the plurality 103 of sets of HIPAA compliant test data with corresponding business processes and with a corresponding plurality of different forms.

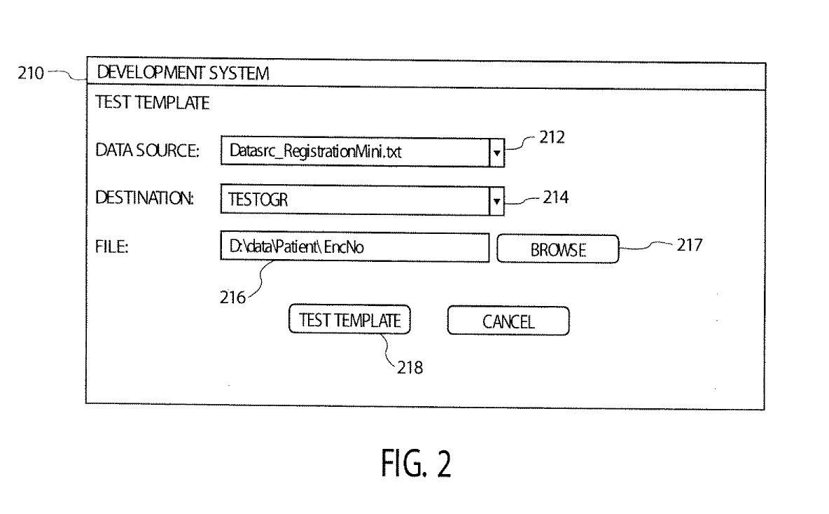

In operation, a developer accesses a template for revision and tests the revised template for proper operation. FIG. 2a and b illustrate respective graphical user interface (GUI) forms used by a developer in the operation of the system for processing and testing of electronic forms according to principles of the present invention. FIG. 2a illustrates a GUI form 202 which is used to select an electronic form template for processing and/or development. Form 202 displays a table 204 with a number of rows. The rows represent respective electronic forms which exist within the development system. The columns represent data associated with the forms, such as the file name, language, development date, production date and so forth. The first row 204a of table 204 represents an admission form. A set 206 of buttons on the left side may be activated by a user to initiate specific processing. A first button 206a permits a developer to introduce a new template into the development system. The developer may upload the new form into the form data repository 104 (FIG. 1) in response to further instructions provided by the GUI 106 (not shown). A second button 206b permits a developer to check-out an existing template. In this case, the developer downloads the template from the form data repository 104 to the developer's computer in response to further instructions provided by the GUI 106. The developer may then revise the template on his computer. A third button 206c permits a developer to check-in a document. In this case, the developer uploads a revised template back to the form date repository 104 from the developer's computer for testing in response to further instructions provided by the GUI 106. Other buttons may be present in the plurality 206 of buttons to provide other functions, such as deleting a template, reverting to a previously saved template, canceling a check-in or check-out and so forth.

The ‘Test template’ button 206d permits a developer to test the selected template using test data from the information repository 102 (FIG. 1). The developer may highlight a row in the table 204a representing an electronic form template. When the developer activates the ‘Test template’ button 206d, the GUI 106 generates a signal representing the image of FIG. 2b . The GUI image of FIG. 2b permits the developer to enter data representing the electronic form template to be tested and the data source to be used to populate the electronic form template. Text box 212 allows the developer to enter a data source (105 of FIG. 1) to be used to populate the electronic form template being tested; text box 214 allows the developer to enter a destination for the electronic from template being tested, i.e. where the populated form is to be distributed for review; and text box 216 allows the developer to enter a file name of the electronic form template being tested. A browse button 217 permits the developer to search the file system for the desired electronic form template file.

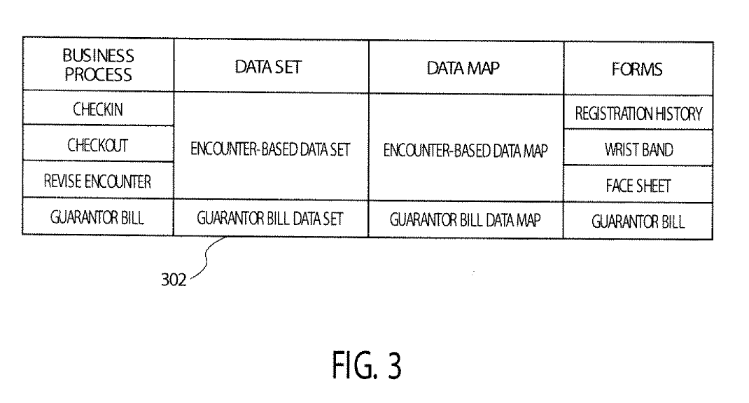

Alternatively, as described above, the information repository 102 (FIG. 1) further includes data 105 associating the plurality of sets of HIPAA compliant test data with corresponding business processes and with a corresponding plurality of different electronic forms. FIG. 3 is a table 302 illustrating a portion of data associating a plurality of sets of HIPAA compliant data with corresponding business practices and different electronic forms according to principles of the present invention. The respective rows of table 302 represent electronic forms and their associated business process, data set and data map. Other information may also be stored in the respective rows. Referring again to FIG. 2, when a developer activates the ‘Test template’ button 206d of FIG. 2a , the GUI image of FIG. 2b is displayed. The data in table 302 of FIG. 3 may be retrieved and used to automatically fill in the data source 212, destination 214 and file data 216 text boxes in form 210 of FIG. 2b.

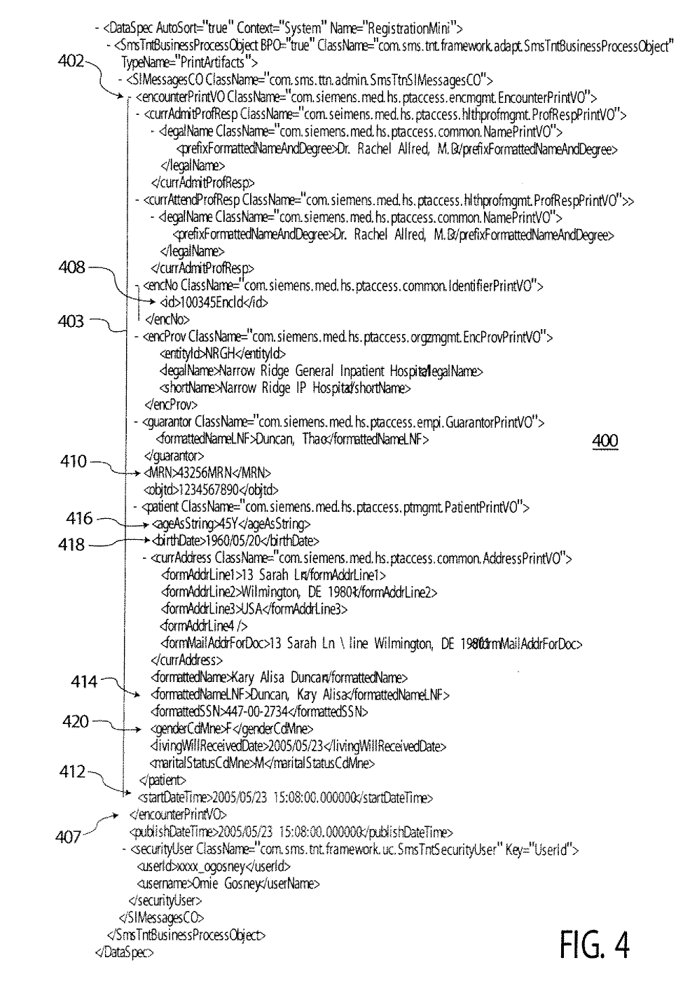

When the appropriate information is entered in FIG. 2b , the ‘Test template’ button 218 may be activated by the developer. In response, the test form generator 110 (FIG. 1) retrieves the set of HIPAA compliant test data associated with the selected electronic form template from the information repository 102. FIG. 4 is a listing 400 of a portion of HIPAA compliant test data for use in processing and testing of electronic forms according to principles of the present invention The portion illustrated in FIG. 4 is associated with an admission form (described in more detail below). In the embodiment illustrated in FIG. 4, the HIPAA compliant test data is in extensible markup language (XML) format. One skilled in the art understands that the HIPAA compliant test data may be stored in XML format, or other suitable format in the information repository 102. Also, data stored in the information repository 102 may be transformed from that format to XML format during the retrieval process. One skilled in the art also understands that XML data is arranged in nested sections surrounded by an opening tag and closing tags. Other sections may be enclosed within a surrounding section.

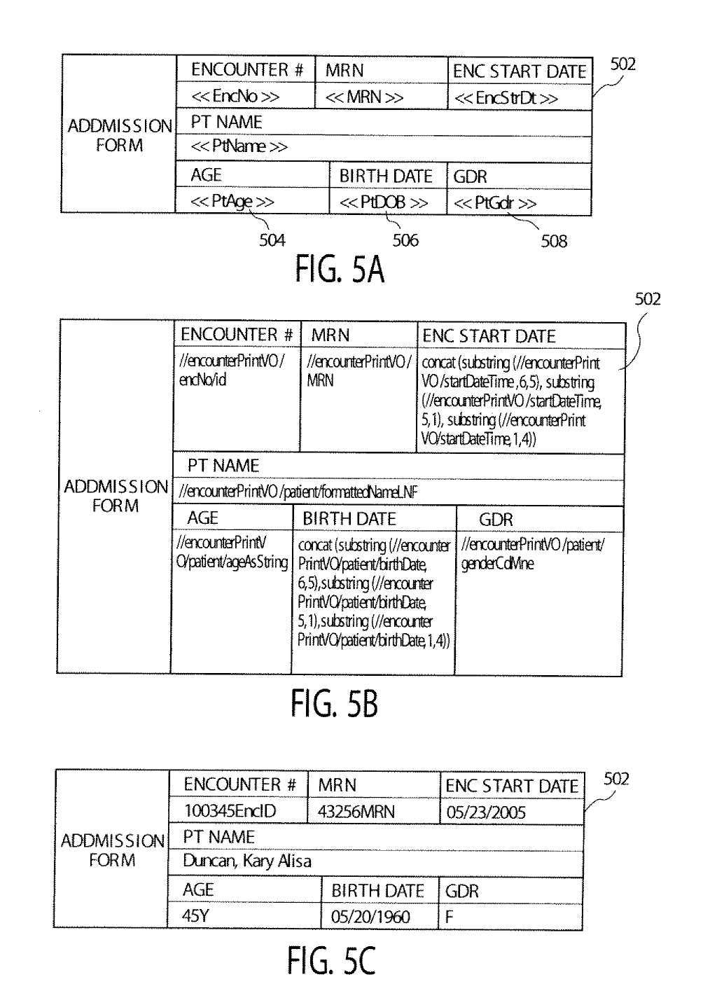

FIG. 5 is a diagram of an electronic form template in various stages of development and test according to principles of the present invention. In FIG. 5a, an admission form 502 includes placeholders, e.g. 504, 506, 508 and so forth. The placeholders are inserted by the developer to indicate where corresponding data items containing data from the information repository 102 (FIG. 1) are to be placed in the electronic form for testing and review; and where actual data items from the healthcare information processing system are to be placed during normal use of the electronic form. For example, the <<PtAge>> placeholder 504 represents a location where patient age data is to be placed; the <<PtDOB>> placeholder 506 represents a location where patient date-of-birth data is to be placed; the <<PtGdr>> placeholder 508 represents a location where patient gender data is to be placed, and so forth. A developer may use form development tools available on his computer, e.g. the mail merge functionality of Microsoft Word™, to develop an electronic form template and place placeholders at desired locations.

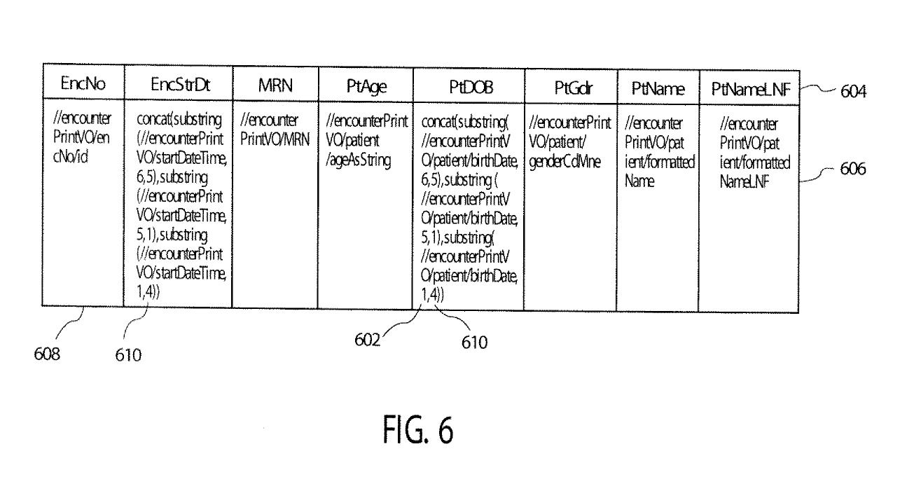

FIG. 6 is a table 602 of a mapping between placeholders for use in developing electronic form templates and corresponding data items according to principles of the present invention. The table 602 illustrated in FIG. 6 includes a plurality of columns representing respective mappings of placeholders to data. The top row 604 contains placeholders and the bottom row 606 contains data specifying the data item corresponding to the placeholder.

Referring concurrently to FIG. 4, FIG. 5, and FIG. 6, a placeholder, e.g. 504, 506, 508, (FIG. 5) is inserted into an electronic form template 502 by the developer. The data map table 602 (FIG. 6) indicates the data item location in the HIPAA compliant test data corresponding to that placeholder. For example, the column 608 in table 602 contains data related to the encounter number placeholder, <<EncNo>>. According to table 602, the location in the HIPAA compliant test data containing the data to populate the encounter number placeholder, <<EncNo>> is “//encounterPrintVO/encNo/id”. This specifies the section in the HIPAA compliant test data illustrated in FIG. 4 designated by the “<encounterPrintVO . . . >” tag 402. All tags between the “<encounterPrintVO . . . >” opening tag 402 and the corresponding “</encouterPrintVO>” closing tag 407 are in the “encounterPrintVO” section 403. Similarly, all tags between the opening “<encNo . . . >” tag and the corresponding closing “</encNo> tag are in the “encounterPrintVO/encNo” section.

The data items may also include functions for generating a data item which is the result of calculation or other manipulation of one or more data locations in the HIPAA compliant test data. For example, columns 610 of table 602 in FIG. 6 specify respective string functions of a concatenation of several substrings of an associated date string in the HIPAA compliant test data. One skilled in the art will appreciate that the dates stored in the HIPAA compliant test data are stored in the format: yyyy/mm/dd, where yyyy represents a 4 digit year, mm represents a 2 digit month and dd represents a 2 digit date; and will further appreciate that the functions specified in columns 610 rearrange the format of the date to the format more commonly used in the United States: mm/dd//yyyy. FIG. 5b illustrates an electronic form template 502 in which data item specifications from the map table 602 are substituted for the placeholders in the electronic form template 502.

When the ‘Test template’ button 218 of FIG. 2b is activated, the test form generator 110 (FIG. 1) evaluates the electronic form template 502 (FIG. 5). When a placeholder is found, the data map 602 (FIG. 6) is accessed to determine the location in the HIPAA compliant test data containing the data to populate that placeholder location, calculating the results of functions, if any. The data items, calculated if necessary, are inserted in place of the placeholders and the populated electronic form template is produced. It may be displayed on one or more display devices 115 (FIG. 1), or printed and distributed as paper copies, for review.

More specifically, in FIG. 4, the data item 408 corresponding to the encounter number placeholder, <<EncNo>>, (e.g. “//encounterPrintVO/encNo/id”) is located between the opening <id> tag and corresponding closing </id> tag, and is “100345Encld”. The data item 410 corresponding to the medical record number placeholder, <<MRN>>, (e.g. “//encounterPrintVO/MRN”) is “43256MRN”; the patient age <<PtAge>> data item 416 is “45Y”; the patient gender <<PtGdr>> data item 420 is “F”; and the patient name <<PtNameLNF>> data item 414 is “Duncan, Kary Alisa”. The encounter start date <<EncStrDt>> is a function calculated from the data item 412 “2005/05/23 15:08:00:00000000”, and has the value “05/23/2005”; and the patient date of birth <<PtDOB>> is a function calculated from the data item 418 “1960/05/20”, and has the value “05/20/1960”. When an electronic form template 502 (FIG. 5) is populated, these values are substituted for the corresponding placeholders. FIG. 5c illustrates an electronic form template 502 in which data values, calculated if necessary, are in the appropriate locations in the form. The form template 502 illustrated in FIG. 5c may be displayed on one or more display devices 115 (FIG. 1) or printed and distributed in paper form for review.

Referring again to FIG. 1, to populate an electronic form template, the test form generator 110 generates an extensible style sheet language (XSL) compatible template from the electronic form template data received from the form data repository 104. The test form generator 110 also generates a map (FIG. 6) associating one of the plurality of sets of HIPAA compliant test data from the information repository 102 with the electronic form. In the illustrated embodiment, the XSL compatible template includes an XML map associating the set of HIPAA compliant data with the electronic form.

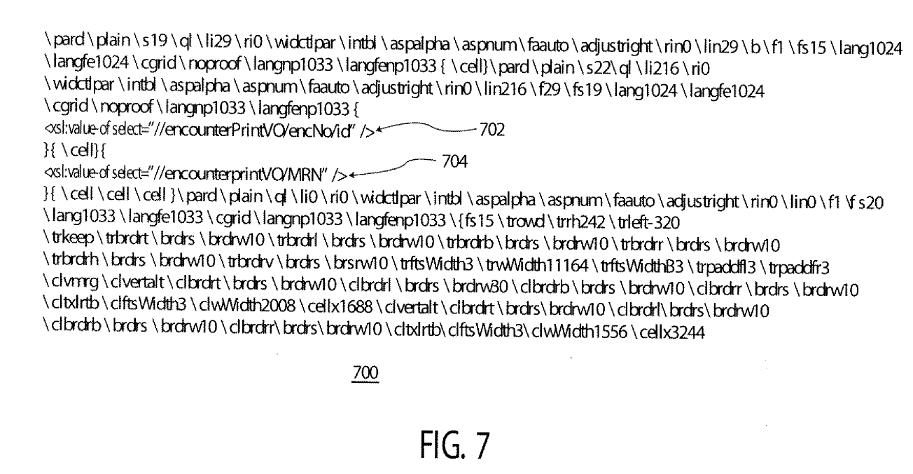

FIG. 7 illustrates a portion 700 of such an XSL compatible template. One skilled in the art understands that the XSL compatible template includes data representing the format of the electronic form template 502 (FIG. 5) and data representing the location of data in the HIPAA compliant test data at locations where that data is to be substituted. For example, in FIG. 7, position 702 of the illustrated portion of the XSL compatible template illustrates data which represents the location of the encounter number data in the HIPAA compliant test data, e.g. “//encounterPrintVO/encNo/id”, at the location where that data is to be displayed in the electronic form template 502. Similarly, position 704 represents the location of the medical record number data in the HIPAA compliant test data, e.g. “//encounterPrintVO/MRN”, at the location where that data is to be displayed. The test form generator 110 (FIG. 1) uses the generated XSL template and XML map to access the appropriate data from the appropriate set of HIPAA compliant test data and to produce the populated electronic form template.

In this manner, the test form generator 110 (FIG. 1) automatically populates the electronic form by merging one of the plurality of sets of HIPAA compliant test data using the XML map into the XSL template. As described above, the automatically populated form may be displayed on a display device 115, or may be printed and distributed manually for review. In addition, a file may be generated containing data representing the populated electronic form. The test form generator 110 may generate at least one of: (a) a rich text format (rtf) file, (b) a portable document format (pdf) file, and/or (c) a text document format (txt), representing the populated electronic form. In this case the output generator 112 routes the rtf, pdf, or txt file to the user for reproduction and review at their own computer. One skilled in the art understands that other file formats may also be generates, such as Microsoft word (doc) Word perfect (wpd) or various image formats such as tagged image format (tif), joint picture group (jpg) bitmapped picture (bmp) format, and so forth.

As described above, the information processing system illustrated in FIG. 1 does not require real (non-test) data. Instead, the test form generator 110 uses the test data information from the information repository 102 in automatically populating the electronic form in a healthcare information system. Thus, the system is capable of generating and communicating documents in the absence of: (a) real (non-test) patient data, (b) real (non-test) physician data, and/or (c) set-up of the healthcare information system for operational (non-test) use. More specifically the test form generator 110 uses the test data information in automatically populating test electronic form with test HIPAA compliant set of data in a healthcare information system. The system is capable of generating and communicating documents in the absence of at least one of: (a) a real (non-test) patient data master file, (b) a physician data master file, and (c) a database of test healthcare information set-up for operational (non-test) use. In particular, the output generator is able to provide the populated electronic form to the user for reproduction and review in the absence of availability of: (a) real (non-test) patient medical record data, and/or (b) physician data indicating physician names and specialties.

What is claimed is:

1. A system for processing and testing of electronic forms and associated templates, comprising:
a repository including data representing different electronic forms;
a repository of information including a plurality of sets of HIPAA compliant test data associated with a plurality of different electronic forms, said HIPAA compliant test data being for use in populating a plurality of different electronic forms for review;
a user interface for providing data representing at least one display image enabling a user to select an electronic form from said form repository;
a test form generator for using said test data in automatically populating an electronic form selected by a user via said user interface with a HIPAA compliant set of data; and
an output generator for providing a populated electronic form to a user for reproduction and review.

2. A system according to claim 1, wherein said test form generator uses said test data information in automatically populating said electronic form with said HIPAA compliant set of test data in a healthcare information system capable of generating and communicating documents in the absence of at least one of: (a) real (non-test) patient data, (b) real (non-test) physician data, and (c) set-up of said healthcare information system for operational (non-test) use.

3. A system according to claim 1, wherein said test form generator uses said test data information in automatically populating said electronic form with said HIPAA compliant set of data in a healthcare information system capable of generating and communicating documents in the absence of at least one of: (a) a real (non-test) patient data master file, (b) a physician data master file, and (c) a database of said healthcare information set-up for operational (non-test) use.

4. A system according to claim 1, wherein said information further comprises data which associates said plurality of sets of HIPAA compliant test data with corresponding business processes and with a corresponding plurality of different electronic forms.

5. A system according to claim 1, wherein said test form generator generates an XSL compatible template from electronic form representative data and a map associating one of said plurality of sets of HIPAA compliant test data in said information repository with said electronic form.

6. A system according to claim 5, wherein said XSL compatible template includes an XML map associating said one of said plurality of sets of HIPAA compliant data with an electronic form.

7. A system according to claim 6, wherein said test form generator automatically populates the electronic form by merging one of said plurality of sets of HIPAA compliant test data using the XML map into said XSL template.

8. A system according to claim 7, wherein:
the test form generator generates at least one of: (a) an rtf file, (b) a pdf file, and (c) a txt file, representing the populated electronic form; and
the output generator routes the rtf, pdf or txt file to the user for reproduction and review.

9. A system for processing and testing of electronic forms and associated templates, comprising:
a repository including data representing different electronic forms;
a repository of information including a plurality of sets of HIPAA compliant test data associated with a plurality of different electronic forms, said HIPAA compliant test data being for use in populating a plurality of different electronic forms for review;
a user interface for providing data representing at least one display image enabling a user to select an electronic form from said form repository;
a test form generator for using said test data in automatically populating an electronic form selected by a user via said user interface with a HIPAA compliant set of data for use in a healthcare information system capable of generating and communicating documents prior to set-up of said healthcare information system for operational (non-test) use; and
an output generator for providing a populated electronic form to a user for reproduction and review.

10. A system according to claim 9, wherein:
said test form generator is able to use said test data in automatically populating said electronic form; and
said output generator is able to provide said populated electronic form to said user for reproduction and review in the absence of availability of one of: (a) real (non-test) patient medical record data, and (b) physician data indicating physician names and specialties.

11. A method for processing and testing of electronic forms and associated templates, comprising the activities of:
providing data representing different electronic forms;
providing information including a plurality of sets of HIPAA compliant test data associated with a plurality of different electronic forms, said HIPAA compliant test data being for use in populating a plurality of different electronic forms for review;
providing a user interface via data representing at least one display image enabling a user to select an electronic form from said different electronic forms;
using said test data in automatically populating an electronic form selected by the user via the user interface with a HIPAA compliant set of data; and
providing a populated electronic form to a user for reproduction and review.

12. A method for using a system for processing and testing of electronic forms and associated templates comprising a repository of data representing different electronic forms, a repository of information including a plurality of sets of HIPAA compliant test data associated with a plurality of different electronic forms, and a user interface for providing data representing at least one display image enabling a user to select an electronic form from said form repository, comprising the activities of:
manipulating the user interface to select an electronic form and an associated set of HIPAA compliant test data associated with the selected form; and
manipulating the user interface to condition a test form generator to automatically populate the selected electronic form with the associated HIPAA compliant set of data and to condition an output generator to provide a populated electronic form to the user for reproduction and review.
